(19) United States
(12) Patent Application Publication
(10) Pub. No.: US 2020/0156167 A1
(43) Pub. Date: May 21, 2020

(54) CUTTING TOOL AND A METHOD FOR PRODUCING THE CUTTING TOOL

(71) Applicant: HUSQVARNA AB, HUSKVARNA (SE)

(72) Inventor: Thierry Gillet, Bruxelles (BE)

(21) Appl. No.: 16/620,984

(22) PCT Filed: Jun. 12, 2017
(86) PCT No.: PCT/SE2017/050624

§ 371 Date: Dec. 10, 2019

(51) Int. Cl. B23D 65/00; B28D 1/12; B28D 1/04; B23K 26/28

(52) U.S. Cl. CPC B23D 65/00; B28D 1/121; B23K 26/28; B28D 1/041; B28D 1/127

(57) ABSTRACT

The invention relates to a method for producing and a cutting tool, respectively, for cutting hard materials such a natural stone or concrete or the like. A ductile support body (2) is the base body of the cutting tool, and a plurality of cutting modules (1) are arranged on the cutting edge of the cutting tool. The cutting member(10) is mounted on an intermediate support member (11), preferably by a laser weld (15), to form said cutting module (1). The modules (1) are attached to the support body (2) by means of a weld (14) in accurate manner, preferably by assistance of abutting support surfaces (120, 121, 123; 20, 21, 23) that hinder movement in at least 2 orthogonal directions, before welding each module (1) onto the support body (2). The invention enables production of pre-fabricated cutting modules (1) at central production sites, e.g. having expensive laser welding equipment, and shipment of these small pre-made modules (1) to distant locations where simple standard welding techniques may be used to produce a cutting tool.

### TECHNICAL FIELD

This invention relates to a cutting tool for cutting hard materials, comprising a support body equipped with a plurality of cutting modules fixedly attached to one edge of the support body. It also relates to a method for producing such a cutting tool.

### BACKGROUND

It is recognized that in order to carry out cutting, drilling or grinding work of hard materials of natural or synthetic stone such as concrete, mainly for civil engineering and construction, tools based on diamond or similar highly abrasive resistant material in cutting edges are used. The tools consist on the one hand of a support member, with high ductility, and with grains of highly abrasive resistant material or similar on the cutting edges at the periphery of the support body.

The highly abrasive material is frequently grains or dust of diamonds, natural or synthetic, but other highly abrasive materials such as tungsten carbide made be used instead or in combination, e.g. sintered to form a cutting member.

The highly abrasive material is to be located on an outer edge of a support body that may have a circular form, as in cutting discs, or a tube form, as in drill bits for cutting out a circular hole, or alternatively in a plate form, as in saw blades. The cutting devices may be made by powder metallurgy, by brazing under Vacuum or by electrolytic deposition incorporating these grains or powders of the highly abrasive resistant material. Hence, it is known that the cutting member may either be applied directly to the support body or in the form of a sintered cutting member directly attached to the support body.

The sintered cutting members are normally not easily compatible to be welded directly on the support body, but therefore need laser welding. It is well known that the laser welding method used to weld these cutting edges onto a support body requires a sophisticated and costly installation which also requires a very good qualification of the operators. The tools used to apply the sintered cutting members of highly abrasive resistant material to the support body are known to be complex and expensive and must be adapted to the geometry of each tool (i.e. shape of each steel support member). It is also recognized that the installation thus constructed has the advantage of assembling large quantities of identical parts at reduced costs. The amortization of the invested capital is directly proportional to the quantities produced. However, this universally applied method is not at all appropriate in the case of regular assembly workshops which are not set up to produce large quantities of similar product, but instead varying products depending on the fluctuating market need. Accordingly, the general existing need on the market does not fit into the existing structure.

For example the manufacturing operations for diamond coated cutting tools are very often complex and involve very different geometries in shapes and dimensions of the final cutting tool, with the consequence that the total production time proves to be relatively long. Supply logistics, production planning and inventory management are complicated and costly. However, a company established worldwide thanks to its sales network must optimize this global flow to meet market demands which are often pressing in terms of price and lead time. There is therefore a need to drastically reduce this global logistics chain by considering short processes and decentralized steps with appropriate new techniques. The possibility of shortening without prejudice to the quality, performance and safety of the products should be considered.

Assembly techniques have evolved considerably thanks to the advent of robotic assembly lines in metal constructions. The fastening controlled by means of deformation, riveting, clamping has developed considerably and is applied when the mechanical stresses in use remain moderate. Automatic welding techniques with or without filler metal also developed decisively when the mechanical stresses were high. One might therefore think that it would be decisive to consider these technological advances to apply them to this problem.

All in all this results in a limited amount of workshops that may produce such cutting tools, which in turn leads to high costs, e.g. due to transportation of heavy cutting tools.

### SUMMARY OF THE INVENTION

It is an object of the invention to minimize, or indeed eliminate, at least one of the problems mentioned above by providing a new method for producing a cutting tool as defined in claim 1 and also to provide a cutting tool as defined in claim 9.

Thanks to the invention many advantages are gained, e.g. that the current logistics chain may be drastically reduced and costs saved, thanks to enabling factory-manufactured modules of highly abrasive resistant material to be assembled on the tool/support bodies where the demand for use is made, i.e. close to the location for final usage. Further, by merely shipping relatively small modules of highly abrasive resistant material, cutting modules, (small space demand and lightweight), and assembling locally, large and heavy support bodies need not be transported, such that excessive CO2 footprint may be eliminated.

For an obvious economic reason, laser beam welding cannot be decentralized due to high investment costs for laser welding equipment. High investment of laser welding equipment, requirements on certified operators and maintenance costs all demonstrate that this technique is not conceivable for decentralized production due to low production volume assemblies. The situation is diametrically opposed regarding advanced standard welding techniques, with low investment and more accessible to standard operators. Accordingly, the invention is synergistic in regard of today's structure.

The description is using following terminology,
Support body: The base body of the cutting tool most often representing 70-95% of the total weight of the cutting tool, and preferably made in a ductile steel quality that is easily machined and welded in most regular local workshops.
Cutting member: A cutting member comprising sintered grains or powder of highly wear resistant abrasive material, preferably with a hardness matching that of natural or synthetic diamonds, which need to be applied on a support member by means of using expensive laser beam welding technology.
Support member: A support member having the cutting member, with the abrasive material, welded onto it and arranged with support surfaces for accurate attachment to the support body.

By this design with an intermediate support member with guiding surfaces, may the module with abrasive material be welded to the support body using regular welding technique. Especially if the intermediate support member is made in a steel quality compatible with the steel support member. Hence, said compatibility enabling standard welding technique such as MIG, MAG, Micro-MIG, Cold Metal Transfer, TIG or Plasma TIG when welding the cutting module onto the support body.

Moreover, the inventive cutting tool preferably is hindered two move in at least two different directions prior to welding, in order to more easily achieve good accuracy. In the most simple form of this preferred embodiment movement is prevented in a first direction, for example vertically downwards by the main body of the supporting member, and in a second direction, for example radially inwardly by at least one leg protruding from the main body of the cutting module, e.g. for producing a cutting disc, enabling mounting of the cutting module to the support body with accuracy prior to welding, without any need to perform measurements.

In a more preferred embodiment of the support member may be arranged with two legs and/or at least one leg with protrusions to achieve form locking, hindering movement in a at least 3, preferably 4 orthogonal directions. Further, in order to obtain possibly improved form locking between the cutting module and the support body, a variety of protrusions and recessed parts may be applied.

In a further embodiment the cutting tool according may have a void located in a part between the two abutting guide surfaces. The void may reduce the total area of the abutting surfaces that needs to be machined down to small tolerances on the support body as well as on the modules. However, the void may be filled with a filling metal Said filling by means of welding torch, brazing torch or possibly soldering.

According to a further preferred aspect the cutting tool is arranged with a gap or a slot between neighbouring cutting modules. The gap facilitates efficient cooling during mounting of the modules and provides for transport of cooling liquid and/or removed material during operation.

Further advantageous aspects of the invention will become evident from the following description.

The cutting tool according to invention may be made in several different shapes, and the support body may be shaped alternatively, e.g. as;
a. a disc with the abrasive resistant edges on the outer radial periphery of the disc, forming a circular saw blade for hard materials, or
b. a circular tube with the abrasive resistant edges on the axially directed end edges of the tube forming a hole drill for hard materials, or
c. an elongated blade with the abrasive resistant edges on one edge of the elongated blade, forming an elongated saw blade.

In summary, the present invention enable production of a cutting, drilling or grinding tool in two distinct stages, the abrasive resistant modules, often diamond parts, being produced in large series in specific production centres having the capacity to use laser beam welding, and these modules being sent and assembled in local manufacturing workshops as close as possible to the places where they are used, where no laser beam welding capacity is at hand nor needed.

### BRIEF DESCRIPTION OF FIGURES

In the following the invention will be described in more detail with reference to exemplary embodiments, wherein;

FIG. 1; shows a side view of a section of a cutting disc, according to the invention, having cutting modules mounted on the outer radial periphery of the disc,

FIG. 2, shows a side view of a first embodiment of a cutting module, according to the invention,

FIG. 3, schematically shows different available general welding techniques for welding the cutting modules on a support body, according to the invention,

FIG. 4, shows a side view of a second embodiment of a cutting module mounted on the edge of a support body, according to the invention,

FIG. 5, shows a side view of a third embodiment of a cutting module mounted on the edge of a support body, according to the invention,

FIG. 6, shows a plurality of alternate exemplary designs of a cutting module, according to the invention,

FIG. 7, shows a side view of a fourth embodiment of a cutting module mounted on the edge of the steel support member, according to the invention,

FIG. 8, shows a perspective view of a preferred embodiment of the cutting module, according to the invention, and

FIG. 9, shows a side view of a cutting module of FIG. 8.

### DETAILED DESCRIPTION

In FIG. 2, a first embodiment of a cutting module 1, according to the invention, is shown having a cutting member 10 of sintered diamond grains/powder applied to a support member 11 by means of a weld 15, i.e. a support member 11 that in the final product is positioned intermediate the cutting member 10 and the support body 2. The weld 15 applied, normally needs to be in the form of a laser weld. Alternatively, the cutting member 10 and the support member 11 are integrated during sintering of the diamond part, i.e. by means of powder metallurgy. Accordingly, the process of applying the abrasive surface, i.e. the cutting member 10 is requiring costly and specialized equipment.

In the embodiment shown in FIG. 2 the support member 11 is schematically shown with welding material 14 applied to it, i.e. welds 14 that are for attachment of the cutting module 1 to a support body 2, preferably made of steel. One of the welds 14A extends along an underside 130 of a base plate 13 of the support member 11. As is evident for the skilled person that single weld 14A may in most applications provide sufficient strength, implying that a parallel epipetric base plate 13 (not shown) is sufficient in many applications, according to the invention.

However, according a preferred design the support member 11 has a base plate 13, with at least one leg 12, to provide improved strength and accuracy, by providing more than one support surface interacting with complementary support surfaces in the support body, as disclosed in the embodiments shown in the figures.

In FIG. 2 the support member 11 is shown to include a base plate 13 with two legs 12 at each end of the base plate, the legs 12 protruding in a direction away from the cutting member 10. The legs 12 are arranged with enlarged areas 12A at the lower end of each leg 12, presenting opposing curved protrusions.

The design of the support member 11 preferably thereby enables form locking of it on the support body 2. Accordingly, such a cutting module 1 may provide a mounting on a support body providing exact form fit, i.e. presenting module supporting surfaces 120, 121, 123, 130 hindering movement in four different orthogonal directions. The two opposing side surfaces 120 of the legs 12 hindering movement both clockwise as well as counter clockwise, the upper surface 121 of the enlarged areas 12A hindering movement outwards and the surface 123 at the end of each leg 12 hindering movement inwards. As is evident for the skilled person the invention also provides the basic function, by the use of a support surface abutting in merely one direction (as described above), or support surfaces abutting in two orthogonal directions (only one leg without projection on the leg) or support surfaces abutting in three orthogonal directions (only one leg at one end and with one projection on one side of the leg or two legs without any projections)

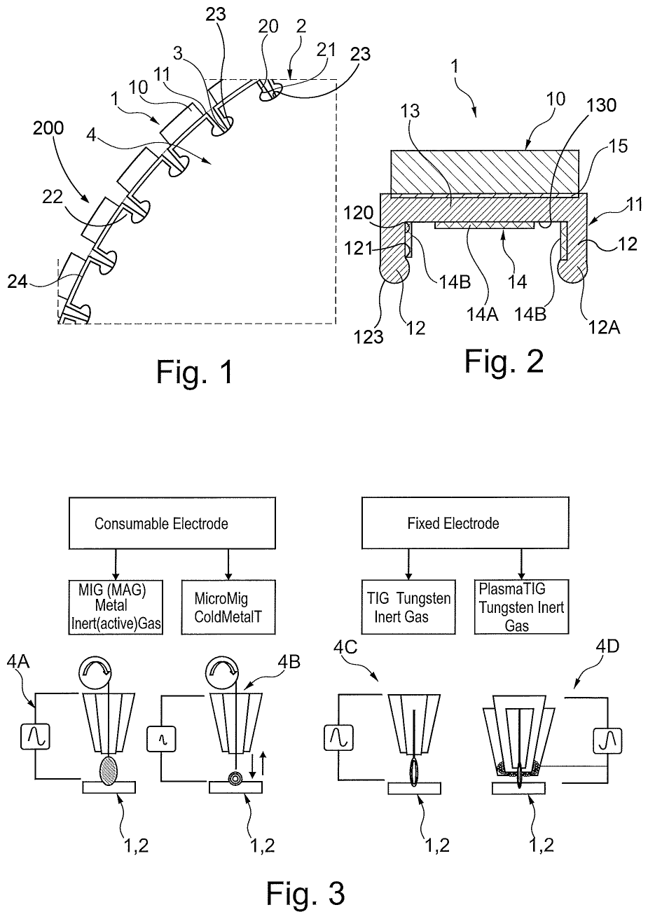

In FIG. 1 there is shown a part of a cutting disc, i.e. the cutting tool, with the cutting modules 1 mounted at the periphery of support body 2, i.e. in this case the disc. The support body 2 is arranged with a plurality of sets 200 of complementary (to the shape of the support member 11) support surfaces 20, 21, 23, 24. Each cutting modules 1 is pushed (in the direction of viewing in FIG. 1) over the corresponding shape of the support body 2, thus straddling over the radially directed protrusions 22 of the support body, thereby proving for the complementary support surfaces 20, 21, 23, 24; 120, 121, 123, 130 to come into abutting contact with each other. Once pushed into place, one or more welds 14 are applied by standard techniques to fixedly attach each cutting modules 1. Accordingly, there is no need of making any measurements or use of complex fixtures when welding. As shown in FIG. 2 welds may be applied in the form of sections (or spots), e.g. including both horizontal parts 14A and vertical parts 14B, but preferably one continuous weld 14 is applied along the abutting surface.

As evident from FIG. 1 the support surfaces are oriented in the radial direction as well as the circumferential directions of the cutting tool, in this case a cutting disc, i.e. by using the two legs on the support member 11 movement is prevented in both circumferential directions, i.e. both clockwise as well as counter clockwise, and in both radial directions, i.e. both radially outwardly as well as radially inwardly.

According to a further preferred aspect shown in FIG. 2, the cutting tool is arranged with a gap 3 between neighbouring cutting modules 1, i.e. the outer sides 126 of the cutting modules 1 (see FIG. 8). The gap 3 facilitates efficient cooling during welding of the cutting modules 1 and provides for transport of cooling liquid and/or removed material during operation.

As seen in the embodiment shown in FIG. 1 the base plate 13 with the two legs 12 form a U-shaped female type of interfit, and each set 200 on support body 2 form a complementary U-shaped male type of interfit.

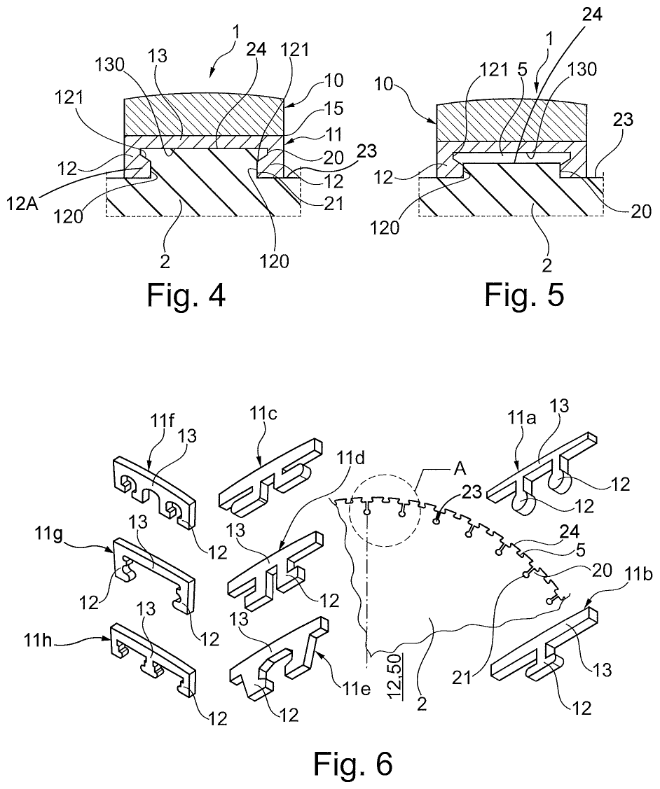

In FIG. 3 are shown examples of standard welding techniques that may be used for welding the cutting module 1 to the support body 2. The welding technique and/or the type of welding material, braze welding or soldering are chosen from those which best meet the needs locally, e.g. best price in combination with providing sufficient mechanical properties. The regular welding techniques covered by the invention are numerous, ranging from conventional welding processes without filler material, e.g. MIG/MAG or Micro-MIG or Cold Metal Transfer, as shown in FIG. 4A or 4B or with filler material, e.g. TIG or PlasmaTIG, as shown in FIG. 4C or 4D, to hot or cold brazing/soldering processes with or without fusion of the parts 1,2 to be joined.

The intermediate support member 13 may have various shapes in accordance with the invention. Examples of form locking non-exhaustive embodiments are shown in FIG. 6, wherein;
11 a show an alternative with two legs 12 with circular end members on the legs;
11b show an alternative with a single T-shaped leg;
11c, 11d and 11e show alternatives with two L-shape legs;
11f show an alternative with 4 L-shaped legs;
11g, show an alternative with 2 L-shaped legs with additional protrusions; (also shown in FIGS. 8 & 9) and 11h the same but with an additional third leg centrally.
11e, shows an alternative with two L-shaped legs, wherein many of the support surfaces are arranged at a sharp angle in relation to the radial direction of the tool.

In FIG. 4 there is shown and alternative embodiment where the intermediate support member 11 is prevented from moving in both radial directions, i.e. inwardly and outwardly, as well as in both circumferential directions, i.e. clockwise and counter clockwise, in a similar manner as described in relation to FIG. 2. However, the design is different in that no curved supporting surfaces are used but instead plane supporting surfaces 120, 121, 123, 124, 130, and thereby also using one angled surface 121. (cf. e.g. 11d in FIG. 6, with also that support surface is plane.)

In FIG. 5 is shown and alternative embodiment where the intermediate support member 11 may be moved in one radial direction, i.e. inwardly until abutting one of the circumferentially extending support surfaces 24 of the support body. Some surfaces do not abut in this embodiment but leaves a cavity 5 intended to be filled with filling material, e.g. a weld 14. The two inwardly radially directed abutting support surfaces 123 are arranged at ends of each leg 12. This embodiment provides more flexibility regarding pre-mounting of the cutting module 1 and further provides that only a relatively small area of the support body 2 needs to be machined to tolerances. The cavity 5 between the support member 11 and the support body 2 may also be left as is if the structural rigidity of the tool is sufficient.

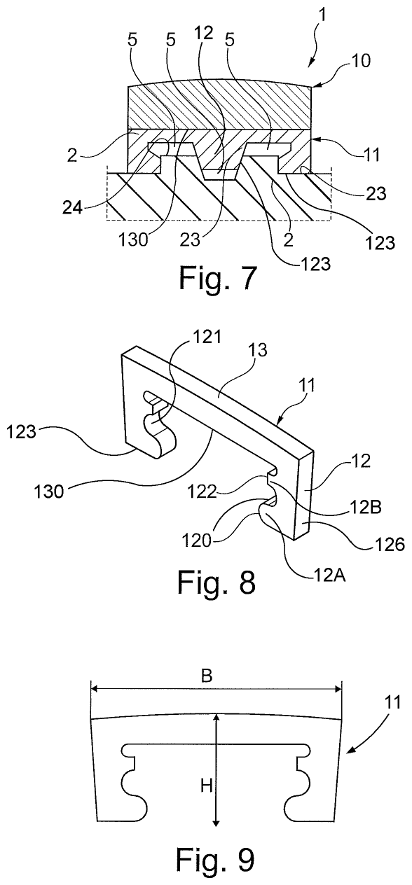

In FIG. 7 is shown a further embodiment, basically similar to that of FIG. 5, but with an additional leg 12 positioned centrally between the outer legs 12. Also here the support member 11 is prevented from moving in one radial directions, i. e. only inwardly, as well as in both circumferential directions, i.e. clockwise and counter clockwise, before welding the cutting module 1 to the support body 2. The additional central leg 12 provides further plane support surfaces 123 that are angled and therefore may assist in abutting in three orthogonal directions. Also here only a small area of the support body 2 needs to be machined to tolerances, due to arranging three cavities 5.

In FIGS. 8 and 9 are shown a preferred support member 11, as also shown in alternative 11g in FIG. 6. It includes 2 L-shaped legs 12, with dual inwardly directed protrusions 12A and 12B on each leg, facing each other. The stress exposure on the module in the radial direction due to centrifugal forces are considerable and therefore dual form locking protrusions 12A and 12B may be needed in some applications. The height H is preferably in the range 12-20 mm, more preferred about 14-16 mm, and with a length B preferably in the range 35-50 mm, more preferred about 38-42 mm, with a thickness similar to that of the support body 2, which may lie in the range 2,5-6 mm, preferably about 3.5 mm.

### Example 1

A low alloyed chromium and molybdenum steel disc hardened and tempered to a Rockwell hardness C between 35 and 40 HRC and having a thickness of 3.5 mm and an outside diameter of 580 mm is laser cut at its periphery in the form shown In FIG. 7, according to a cutting pattern opposite to the shape of the support member 11. In this way, the parts can be nested or embedded with an accuracy that depends on the tolerances of their cutting. At least the support surfaces close to the radial protrusions on the circular support body are preferably cut by laser beam with a tolerance of the order of one tenth of a millimetre, while the remaining outer periphery may be machined with less tolerances. The support members 11 can be obtained by cutting Laser with the same type of tolerance or by stamping or by machining with a milling cutter. The quality of the steel of the support members is substantially similar to that used for the steel support body.

The weld 14 between the cutting module 1 and the support body 2 may be made by the supply of a solder of an alloy with 92% Copper and 8% Aluminium with a diameter of 1 mm giving a good fluidity of the brazing liquid bath, a good bonding of the steel parts and a good filling of the cavities 5 left by the pattern of the support members 11 relative to the cut-outs 200 of the plate of the disc 2 as indicated. In the present example, the width of the cavities 5 is in this case fixed between 1 and 2.5 mm. The support body 2 has a thickness of 3.5 mm. In the present case, a welding torch under argon gas was used with a current ranging from 100 to 110 A and an arc voltage of 17 V and the deposition rate reached an average of 55 cm/min. The mechanical result of the deposit was measured on a specimen with an elastic limit greater than 600 MPa and an elongation at break of the order of 40%. The present assembling case was obtained by attachment by means of three welds located in the three cavities 5 as shown in FIG. 7. The disc thus assembled was tested on a 60 KW ground sawing machine on a concrete slab heavily armed and showed similar results to a conventionally assembled disc.

### Example 2

The same similarly cut steel body 2 was lined with diamond segments 10 attached to their support member 11 by laser beam weld 15. In this case, the support member 11 has been cut in such a way that its embodiment does not have a substantial cavity 5 between it and the body 2 of the tool, as in FIG. 4. The two parts were bonded by autogenous welding using a pulsed Tungsten-Inert-Gas (TIG) argon gas torch with an additional Argon-Carbon dioxide plasma gas in the nozzle. 5%, without filler metal, presenting a weld 14 without filler. The cord made in one pass on each side of the disc was made with a current between 95 and 130 A and a displacement of 60 cm/minute. The penetration of each weld is at least half the thickness of the disc so that, in total, the entire thickness has been welded.

These two non-limiting examples show without doubt that a cutting tool based on use of cutting modules 1, including diamond segments 10, can be efficiently and reliably mounted using an innovative logistic by including decentralized workshop close to demand, enabling use of flexible and inexpensive techniques to attach the diamond parts 10 onto a suitable support body. The support member preferably has a shape such that it advantageously allows the positioning and the embedding of the cutting modules 1 on the support body 1 of the tool so as to guarantee an optimum precision of the assembly obtained.

The generic calculation of the cost and the gain thus achieved is given hereafter by way of example for a disc for cutting concrete floors with a diameter of 600 mm, containing 46 segments 40 mm long. The investment of a laser welding facility costs around 400,000 USD for an average capacity of 80 pieces per day. The conventional welding facility costs some 30,000 USD for an average capacity of 30 pieces per day. Thanks to the invention investments in laser welding facilities may be optimized to a limited number that provides using full capacity, i.e. enabling substantial savings. Further it enables substantial savings thanks to eliminated need of transporting heavy cutting tools, but instead small, light-weight cutting modules 1. Moreover, it provides the advantage that the same cutting module 1 may be used on a large variety of support bodies 2, thanks to being sufficiently small to fit for a variety of differently dimensioned support bodies.

The invention is not limited by the examples and embodiments mentioned above, but may be varied within the scope of the appended claims. For instance, the skilled person realises that the support member 2 must not be arranged with any leg to achieve the main advantages of the invention, but that abutting surfaces in the form of one each on the support body and the support member also fulfils the basic function of the invention. Further it is foreseen that the advantages of the invention may also be achieved by the use of different methods than laser welding to join the support member and the cutting member, e.g. sintering technology.

1. A method for producing a cutting tool for cutting hard materials, comprising a support body equipped with a plurality of sintered cutting members fixedly attached to one edge of the support body via at least one weld, the method comprising:
a) Providing a plurality of sintered cutting members,
b) Providing a plurality of support members with at least one module supporting surfaces on an attachment side,
c) Fixedly join each cutting member with respective ones of the support members to form a cutting module,
d) Providing the support body with a plurality of attachment sets having at least one complementary, counter facing body support surface,
e) pre-mounting each cutting module onto the support body by complementary inter-fitting said at least one module support surface with one of said sets having at least one complementary body support surface, and
f) applying the at least one weld to fixedly attach each one of said cutting modules to said support body.

2. The method according to claim 1, wherein said sintered cutting member is joined with the support members by means of a laser weld.

3. The method according to claim 1, wherein each support member is provided with a plurality of module support surfaces facing in at least 2 different directions and each attachment set is provided a plurality of body support surface, also facing in at least 2 different directions, such that at least a part of the complementary support surfaces in each of the 2 different directions will come into abutting contact with each other preventing movement in at least 2 orthogonal directions.

4. The method according to claim 1, wherein said weld in step d) is applied by a welding technique comprising MIG, MAG, MicroMig, Cold MetalT, TIG or Plasma Tig.

5. The method according to claim 3, wherein said support surfaces are arrange such that each cutting module is prevented from moving in at least 3 orthogonal directions before applying said weld.

6. The method according to claim 3, wherein said support surfaces are arrange such that each cutting module is prevented from moving in at least 4 orthogonal directions before applying said weld.

7. The method according to claim 4, wherein each cutting module, before applying the weld is mounted onto the support body by sliding it axially to achieve abutting contact of the complementary support surfaces.

8. The method according to claim 1, wherein steps a)-c) are performed in a centralized manner at a first location and steps d)-f) are performed in a distributed manner at a plurality of second locations.

9. A cutting tool, comprising a support body equipped with a plurality of cutting modules fixedly attached to one edge of the support body, wherein each cutting module comprises a support member having a sintered cutting member fixedly attached thereto, said support member having at least one module support surface and said support body having a plurality of attachment sets, each attachment set having at least one complementary, counter facing body support surface and wherein said cutting module is joined with said support body by a weld.

10. The cutting tool according to claim 9, wherein said support member is arranged with a main body extending substantially along said cutting member and that said main body at an opposite side in relation to said cutting member is arranged with at least one leg protruding in a direction away from said cutting member and wherein at least one of said module support surfaces arranged on said leg, such that at least a part of the complementary support surfaces hinder movement, also prior to welding, in at least 2 orthogonal directions.

11. The cutting tool according to claim 10, wherein said at least one leg is arranged with a plurality of module support surfaces hinder movement, also prior to welding, in at least 3 orthogonal directions.

12. The cutting tool according to claim 9, wherein said support member is arranged with at least two legs.

13. The cutting tool according to claim 10, wherein said at least one leg or an intermediate space between two legs is formed to provide form fit hindering movement in at least 3 orthogonal directions.

14. The cutting tool according to claim 11, wherein a cavity between edges of the support member and support body is filled with a filling material.

15. The cutting tool according to claim 9, wherein a gap is arranged between each neighbouring cutting module, wherein preferably said gap is, at least partly, defined by outer facing edges of two neighbouring cutting modules.

16. The cutting tool according to claim 9, wherein said cutting member contains grains or powder with a hardness of said grains or powder at least corresponding to the hardness of diamond grains or diamond powder, wherein said grains or powder is in the form of diamond grains or diamond powder.

17. The cutting tool according to claim 9, wherein said support member is in a form of:
a. a disc with the abrasive resistant edges on the outer radial periphery of the disc, forming a circular saw blade for hard materials, or
b. a circular tube with the abrasive resistant edges on the axially directed end edges of the tube forming a hole drill for hard materials, or
c. an elongated blade with the abrasive resistant edges on one edge of the elongated blade, forming an elongated saw blade.

18. The cutting tool according to claim 9, wherein said support member is made in steel and also the support member and wherein the steel quality of said support member is compatible for welding with standard technics with the steel quality of the support member.

19. The cutting tool according to claim 9, wherein said cutting support member by a laser weld is made in steel and also the support member and wherein the steel quality of said support member is compatible for welding with standard technics with the steel quality of the support member.
